(19) United States
(12) Patent Application Publication
(10) Pub. No.: US 2009/0282946 A1
(43) Pub. Date: Nov. 19, 2009

(54) Ergonomic handgrip for bicycle handlebars

(75) Inventor: Giuseppe Bigolin, Casella D'Asolo Treviso (IT)

Correspondence Address: HEDMAN & COSTIGAN P.C., 1185 AVENUE OF THE AMERICAS, NEW YORK, NY, 10036, US

(73) Assignee: SELLE ITALIA S.R.L., CASELLA D'ASOLO(TREVISO) (IT)

(21) Appl. No.: 12/454,133

(22) Filed: May 13, 2009

(30) Foreign Application Priority Data
May 15, 2008 (IT) MI2008A000885

(51) Int. Cl. B62K 21/26

(52) U.S. Cl. 74/551.9

(57) ABSTRACT

An ergonomic handgrip for bicycle handlebars comprises a central body joined to a countered portion extending, starting from the central body, toward the rear of the handgrip with reference to the bicycle advancing direction, the contoured portion defining a top bearing surface, thereon a hand of the user can bear, and a bottom surface, operating as a finger gripping portion for the user hand, the ergonomic handgrip comprising moreover a ventilating arrangement adapted to allow air to circulate through the handgrip.

### BACKGROUND OF THE INVENTION

The present invention relates to an ergonomic handgrip, which has been specifically designed to be fitted to bicycle and the like handlebars.

As is known, to the end portions of a bicycle handlebar are conventionally applied handgrips to facilitate the user hand in gripping the handlebar.

In racing bicycles, either of a road or a racetrack type, the handlebar handgrips usually comprise a fabric material or cork strip, but, in other cases they are mainly constituted by substantially cylindric elements, made of a rubber material, having desired hardness properties.

Yet further handgrips are so contoured or shaped as to provide an improved gripping thereon.

In competitive applications and, in general, in sports bicycles, the handlebar is so designed that a main part of the user weight is applied on the user hands.

In an agonistic and extended use of the bicycle, this can cause a hand weariness, since conventional handgrips do not allow a proper distribution of the user weight on the user hands.

Another problem is that of perspiration which unavoidably occurs on the hands, which continuously contact the handgrips.

It has been tried to overcome the above perspiration problem by using transpiring or sponging materials and coatings, but with poor results, due to the fact that, in each case, the handgrip is associated with a perfectly impermeable element, that is the handlebar tube.

Moreover, weariness and perspiration caused by an extended use of the bicycle handlebar, can reduce the bicycle control capability by the bicycle user.

Thus, it would be of essential importance, both from a comfort and safety standpoint, to improve existing handlebar handgrip constructions.

### SUMMARY OF THE INVENTION

Accordingly, the aim of the present invention is to provide such a handgrip, specifically designed for bicycle handlebars, which is much more efficient than conventional handgrips from an ergonomic standpoint.

Within the scope of the above mentioned aim, a main object of the invention is to provide such a handgrip suitable to reduce weariness of the user hands in an extended use of the bicycle.

Another object of the present invention is to provide such a handgrip allowing an optimum transpiration, thereby reducing negative effects of perspiration.

Yet another object of the present invention is to provide such a handgrip construction which, owing to its specifically designed constructional features, is very reliable and safe in operation.

Yet another object of the present invention is to provide such a handgrip construction which can be easily made starting from easily available elements and materials and which, moreover, is very competitive from a mere economic standpoint.

According to one aspect of the present invention, the above mentioned aim and objects, as well as yet other objects, which will become more apparent hereinafter, are achieved by an ergonomic handgrip, particularly for bicycle handlebars, characterized in that said handgrip comprises a handgrip central body joined to a handgrip contoured portion extending, starting from said central body, toward a rear of the handgrip, with reference to a bicycle advancing direction, said contoured portion defining a top bearing surface, for bearing thereon a user hand, and a bottom surface defining a user hand finger gripping means, said handgrip further comprising ventilating means for allowing air to circulate through said handgrip.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a top plan view of the handgrip according to the present invention;

FIG. 2 is a bottom view, as partially cross-sectioned, of the inventive handgrip;

FIG. 3 is yet another bottom view of the handgrip according to the present invention;

FIG. 4 is an outer side view of that same inventive handgrip;

FIG. 5 is a bottom perspective view, as partially exploded, of the handgrip; and

FIG. 6 is yet another bottom perspective view of the handgrip according to the invention.

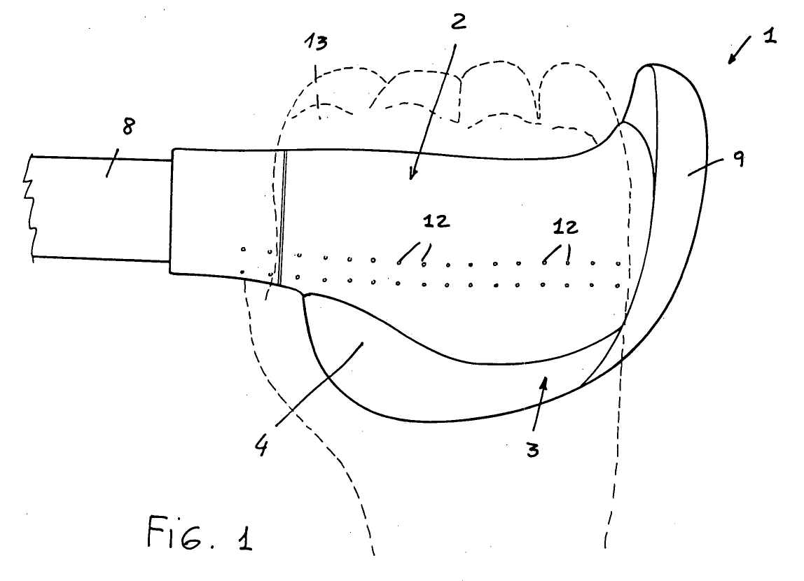

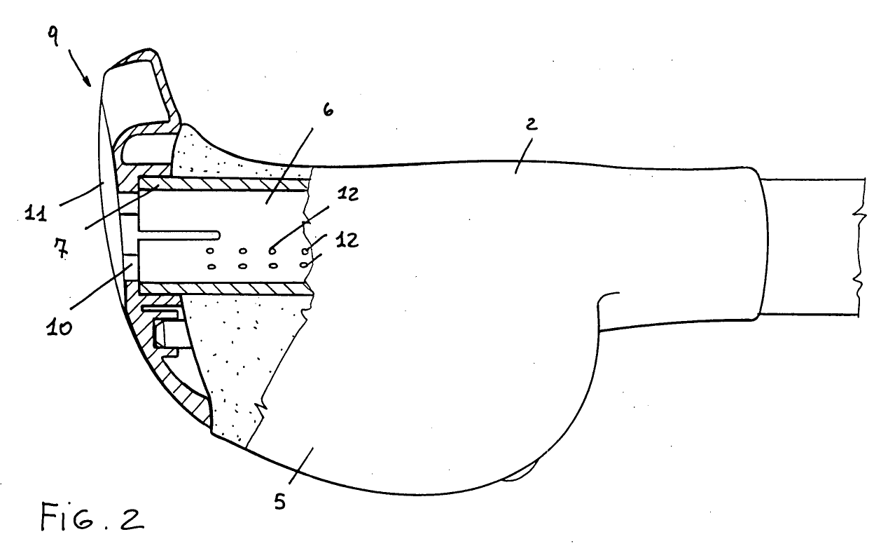

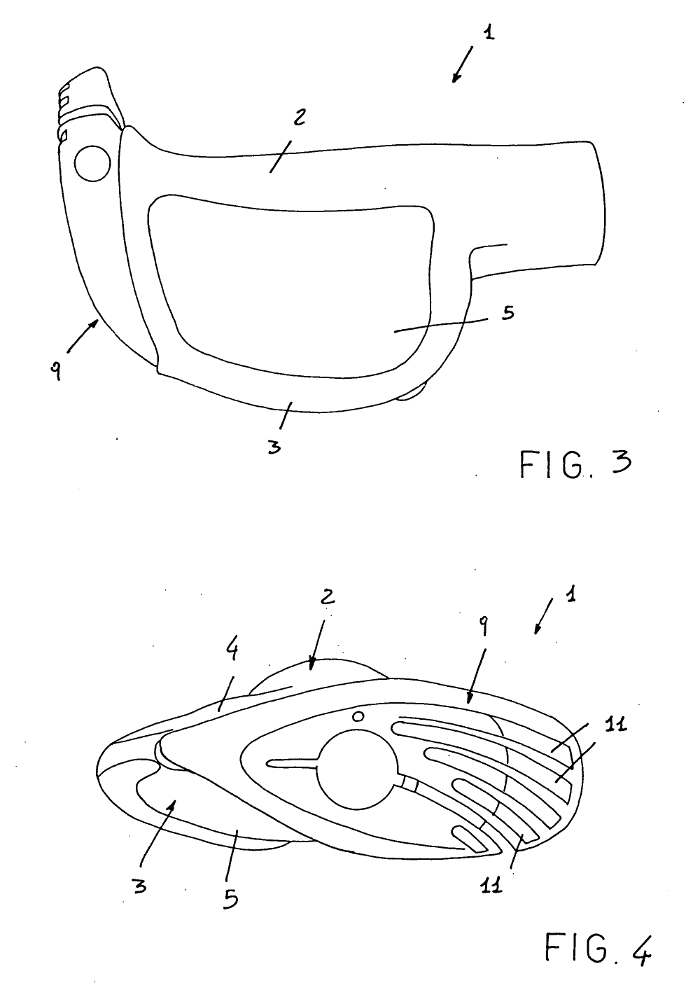

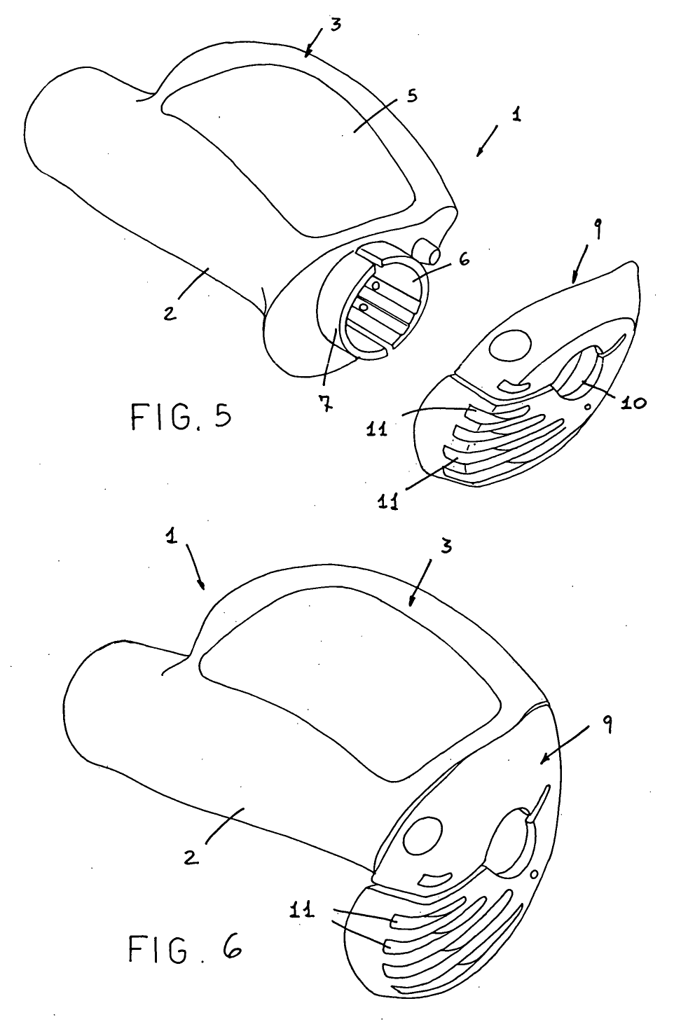

### DESCRIPTION OF THE PREFERRED EMBODIMENTS

With reference to the number references of the above mentioned figures, the handgrip according to the present invention, which has been generally indicated by the reference number 1, comprises a handgrip central body 2, joining with a contoured or shaped portion 3 extending, starting from said central body, to the rear of the handgrip, with reference to the bicycle advancing direction.

In the figures a right handgrip has been shown.

More specifically, said contoured portion 3 defines a top bearing surface 4, thereon a hand of the user can bear, and a bottom bearing surface 5, forming a gripping means for the user hand fingers.

The central body 2 comprises a cavity 6 defined by a tubular element longitudinally extending within the central body and ending with a collar 7 at the outer end portion of the handgrip, that is at the handgrip end opposite to that associated with the handlebar 8.

The collar 7 provides an engagement means for an end contoured element 9 which, in an assembled condition of the handgrip, is coupled to the central body 2 and the contoured portion 3.

The contoured end element 9 comprises an opening 10, coupled to a plurality of air conveying channels 11, adapted to convey an air flow toward said opening 10.

Said opening 10 communicates moreover with the handgrip cavity 6, which comprises a plurality of a aerating holes 12, through the top part of the central body 2.

Thus, the air flow, generated by the movement of the bicycle, will be conveyed, through the channels 11 and opening 10, to the cavity 6 in the central body 2, and will exit the aerating holes 12, thereby refrigerating the user hand 13.

It has been found that the invention fully achieves the intended aim and objects.

In fact, an ergonomic handgrip adapted to greatly reduce the hand weariness and negative effect of perspiration has been provided.

The handgrip according to the present invention is moreover advantageous from the standpoint of improving the bicycle control, thereby allowing an improved gripping on the bicycle handlebar, and reducing weariness and perspiration.

In practicing the invention, the used materials, as well as the contingent size and shapes, can be any, according to requirements.

1. An ergonomic handgrip for bicycle handlebars, characterized in that said handgrip comprises a handgrip central body joined to a handgrip contoured portion extending, starting from said central body, toward a rear of the handgrip, with reference to a bicycle advancing direction, said contoured portion defining a top bearing surface, for bearing thereon a user hand, and a bottom surface defining a user hand finger gripping means, said handgrip further comprising ventilating means for allowing air to circulate through said handgrip.

2. An ergonomic handgrip, according to claim 1, characterized in that said ventilating means comprise an air inlet, adapted to allow an air flow to enter the handgrip, and a plurality of openings communicating a handgrip inner part with a handgrip outer surface thereon a user hand bears, so as to diffuse an air flow through the user hand.

3. An ergonomic handgrip, according to claim 1, characterized in that said central body comprises a central body cavity defined by a tubular element longitudinally extending within said central body and ending with a collar at an outer end portion of the handgrip or at an end portion of said handgrip opposite to that associated with the bicycle handlebar.

4. An ergonomic handgrip, according to claim 3, characterized in that said collar provides engagement means for an end contoured element which, in an assembled condition of the handgrip, is coupled to said central body and contoured portion.

5. An ergonomic handgrip, according to claim 4, characterized in that said contoured end element comprises at least an opening coupled to a plurality of air conveying channels adapted to convey an air flow toward said opening.

6. An ergonomic handgrip, according to claim 5, characterized in that said opening communicates with said cavity of said handgrip, which comprises a plurality of aerating holes through the top portion of the central body.

7. An ergonomic handgrip, according to claim 6, characterized in that said air flow generated by a movement of the bicycle is conveyed through said channels end opening to the central body inner cavity, and exits the aerating holes so as to refrigerate the user hand.
